(19) United States
(12) Patent Application Publication
(10) Pub. No.: US 2018/0105675 A1
(43) Pub. Date: Apr. 19, 2018

(54) TIRE MEMBER, TIRE, TIRE MEMBER MANUFACTURING METHOD, AND TIRE MANUFACTURING METHOD

(71) Applicant: TOYO TIRE & RUBBER CO., LTD., Itami-shi (JP)

(72) Inventor: Takashi Miyasaka, Itami-shi (JP)

(73) Assignee: TOYO TIRE & RUBBER CO., LTD., Itami-shi (JP)

(21) Appl. No.: 15/683,303

(22) Filed: Aug. 22, 2017

(30) Foreign Application Priority Data
Oct. 14, 2016 (JP) 2016-202845

(51) Int. Cl. C08K 5/20; B60C 1/00; C08K 5/24; C08K 3/04

(52) U.S. Cl. CPC C08K 5/20; C08K 3/04; C08K 5/24; B60C 1/0016

(57) ABSTRACT

A tire member in accordance with the present disclosure comprises a rubber composition comprising a compound according to Formula (I), below; a hydrazide compound; and carbon black.

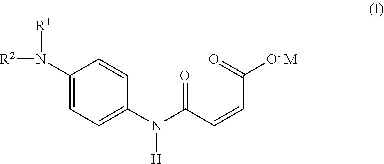

(At Formula (I), R¹ and R² each indicates a hydrogen atom, an alkyl group having 1 to 20 carbons, an alkenyl group having 1 to 20 carbons, or an alkynyl group having 1 to 20 carbons. R¹ and R² may be the same or different. M⁺ indicates sodium ion, potassium ion, or lithium ion.)

### TECHNICAL FIELD

The present disclosure relates to a tire member and tire, and to manufacturing methods for same.

### BACKGROUND ART

Reduction in heat generation is desired for tread rubber and other such tire members.

As art for reducing heat generation, Patent Reference No. 1 describes art in which (2Z)-4-[(4-aminophenyl)amino]-4-oxo-2-butene acid sodium is added to rubber. In connection with (2Z)-4-[(4-aminophenyl)amino]-4-oxo-2-butene acid sodium, Patent Reference No. 1 further discloses that the terminal nitrogen functional group bonds to carbon black and that the carbon-carbon double-bond portion bonds to polymer.

Although the object thereof is not to reduce heat generation, Patent Reference No. 2 describes art in which carboxylic acid dihydrazide or other such coupling agent is added to rubber.

### PRIOR ART REFERENCES

### Patent References

PATENT REFERENCE NO. 1: Japanese Patent Application Publication Kokai No. 2014-95014

PATENT REFERENCE NO. 2: Japanese Patent Application Publication Kokai No. 2016-41779

### SUMMARY OF INVENTION

### Means for Solving Problem

A tire member in accordance with the present disclosure comprises a rubber composition comprising a compound according to Formula (I) (hereinafter “compound according to Formula (I)”), below; a hydrazide compound; and carbon black.

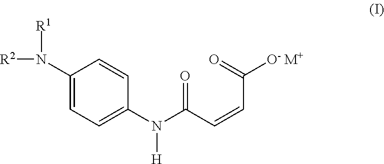

(At Formula (I), R¹ and R² each indicates a hydrogen atom, an alkyl group having 1 to 20 carbons, an alkenyl group having 1 to 20 carbons, or an alkynyl group having 1 to 20 carbons. R¹ and R² may be the same or different. M⁺ indicates sodium ion, potassium ion, or lithium ion.)

A tire member manufacturing method in accordance with the present disclosure comprises an operation in which a rubber composition comprising a compound according to Formula (I), a hydrazide compound, and carbon black is made.

### EMBODIMENTS FOR CARRYING OUT INVENTION

It is an object of the present disclosure to provide a tire and tire member that excel in terms of their reduced heat generation.

A tire member in accordance with the present disclosure comprises a rubber composition comprising a compound according to Formula (I), a hydrazide compound, and carbon black. A tire in accordance with the present disclosure comprises a tire member. A tire member manufacturing method in accordance with the present disclosure comprises an operation in which a rubber composition comprising a compound according to Formula (I), a hydrazide compound, and carbon black is made. A tire manufacturing method in accordance with the present disclosure comprises a tire member manufacturing method. It is preferred that the hydrazide compound comprise a dihydrazide compound.

In accordance with the present disclosure, because a compound according to Formula (I) and a hydrazide compound are used in combination, greater reduction in heat generation may be achieved than when either is used alone. It is thought that the compound according to Formula (I) and the hydrazide compound each react at different sites at active functional groups on the surface of the carbon black, resulting in improved carbon black dispersion characteristics and bringing about reduction in heat generation.

A tire member in accordance with the present disclosure might, for example, be a tread, sidewall, chafer, bead filler, or other such tire member. Of these, it is preferred that it be a tread.

A tire member in accordance with the present disclosure comprises a rubber composition. As rubber component comprised by the rubber composition, natural rubber, isoprene rubber, butadiene rubber, styrene-butadiene rubber, nitrile rubber, chloroprene rubber, and the like may be cited as examples. Of these, natural rubber and/or butadiene rubber is preferred. It is preferred that the amount of natural rubber be not less than 40 mass %, and more preferred that this be not less than 50 mass %, per 100 mass % of the rubber component. The upper limit of the range in values for the amount of natural rubber might, for example, be 100 mass %. The amount of the butadiene rubber might, for example, be not less than 10 mass % per 100 mass % of the rubber component. The upper limit of the range in values for the amount of the butadiene rubber might, for example, be 60 mass %, it being preferred that this be 50 mass %.

The rubber composition comprises a compound according to Formula (I). Formula (I) is indicated below.

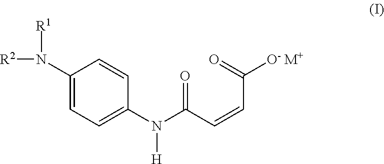

(At Formula (I), R¹ and R² each indicates a hydrogen atom, an alkyl group having 1 to 20 carbons, an alkenyl group having 1 to 20 carbons, or an alkynyl group having 1 to 20 carbons. R¹ and R² may be the same or different. R⁺ indicates sodium ion, potassium ion, or lithium ion.)

At Formula (I), it is preferred that R¹ and R² each be a hydrogen atom. It is preferred that M⁺ be a sodium ion. It is preferred that the compound according to Formula (I) be a compound according to Formula (I′), below.

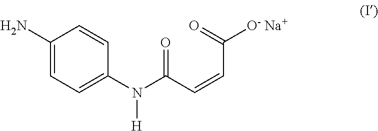

For every 100 parts by mass of the rubber component, it is preferred that the amount of the compound according to Formula (I) be not less than 0.1 part by mass, more preferred that this be not less than 0.2 part by mass, and still more preferred that this be not less than 0.5 part by mass. For every 100 parts by mass of the rubber component, it is preferred that the amount of the compound according to Formula (I) be not greater than 10 parts by mass, more preferred that this be not greater than 8 parts by mass, and still more preferred that this be not greater than 5 parts by mass.

The rubber composition further comprises a hydrazide compound. The hydrazide compound possesses a hydrazide group (—CONHNH₂). It is preferred that the hydrazide compound possess two hydrazide groups within the molecule. In the context of the present disclosure, a hydrazide compound that possesses two hydrazide groups within the molecule is referred to as a dihydrazide compound. As the hydrazide compound, isophthalic dihydrazide, terephthalic dihydrazide, azelaic dihydrazide, adipic dihydrazide, succinic dihydrazide, eicosanedioic acid, 7,11-octadecadiene-1,18-dicarbohydrazide, salicylic hydrazide, 4-methylbenzohydrazide, 3-hydroxy-N′-(1,3-dimethylbutylidene)-2-naphthoic acid hydrazide, and so forth may be cited as examples. Of these, isophthalic dihydrazide and 3-hydroxy-N′-(1,3-dimethylbutylidene)-2-naphthoic acid hydrazide are preferred, and isophthalic dihydrazide is more preferred. It is preferred that the amount of the hydrazide compound be not less than 0.1 part by mass for every 100 parts by mass of the rubber component. For every 100 parts by mass of the rubber component, the upper limit of the range in values for the amount of the hydrazide compound might, for example, be 5 parts by mass, it being preferred that this be 2 parts by mass, and it being more preferred that this be 1 part by mass.

For every 100 parts by mass of the rubber component, it is preferred that the combined amount of the compound according to Formula (I) and the hydrazide compound be not less than 0.2 part by mass, and more preferred that this be not less than 0.5 part by mass. For every 100 parts by mass of the rubber component, the upper limit of the range in values for the combined amount of the compound according to Formula (I) and the hydrazide compound might, for example, 10 parts by mass, it being preferred that this be 5 parts by mass, and more preferred that this be 3 parts by mass. Above 10 parts by mass, workability would likely be impaired.

The rubber composition further comprises carbon black. As examples of the carbon black, besides SAF, ISAF, HAF, FEF, GPF, and other such carbon blacks ordinarily used in the rubber industry, acetylene black, Ketchen black, and/or other such electrically conductive carbon blacks may be used. The carbon black may be nongranulated carbon black or may be granulated carbon black that has been granulated based upon considerations related to the handling characteristics thereof as is ordinary practice in the rubber industry. For every 100 parts by mass of the rubber component, it is preferred that the amount of carbon black be not less than 10 parts by mass, more preferred that this be not less than 20 parts by mass, and still more preferred that this be not less than 30 parts by mass. For every 100 parts by mass of the rubber component, it is preferred that the amount of carbon black be not greater than 80 parts by mass, and more preferred that this be not greater than 60 parts by mass.

The rubber composition may further comprise silica, stearic acid, zinc oxide, antioxidant, sulfur, vulcanization accelerator, and/or the like. As examples of the antioxidant, aromatic-amine-type antioxidants, amine-ketone-type antioxidants, monophenol-type antioxidants, bisphenol-type antioxidants, polyphenol-type antioxidants, dithiocarbamate-type antioxidants, thiourea-type antioxidants, and the like may be cited. For every 100 parts by mass of the rubber component, it is preferred that the amount of antioxidant be not less than 0.5 part by mass, and more preferred that this be not less than 1 part by mass. For every 100 parts by mass of the rubber component, the upper limit of the range in values for the amount of antioxidant might, for example, be 4 parts by mass, it being preferred that this be 3 parts by mass. As the sulfur, powdered sulfur, precipitated sulfur, insoluble sulfur, high dispersing sulfur, and the like may be cited as examples. It is preferred that the amount of the sulfur, expressed as equivalent sulfur content, be 0.5 part by mass to 5 parts by mass for every 100 parts by mass of the rubber component. As examples of the vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited. It is preferred that the amount of the vulcanization accelerator be 0.1 part by mass to 5 parts by mass for every 100 parts by mass of the rubber component.

A tire in accordance with the present disclosure may comprise a tread that is made up of the rubber composition. A tire in accordance with the present disclosure may be a pneumatic tire. A tire in accordance with the present disclosure may be employed as a tire intended for heavy loads. A tire in accordance with the present disclosure may further comprise sidewall(s) made up of the rubber composition, chafer(s) that is made up of the rubber composition, and/or the like.

Three procedures for making the rubber composition will now be given by way of example. A first procedure comprises an operation in which a compound according to Formula (I), a hydrazide compound, and a rubber component are mixed to obtain a mixture, and an operation in which a vulcanizing-type compounding ingredient is kneaded into the mixture. A second procedure comprises an operation in which a compound according to Formula (I), an antioxidant, and a rubber component are mixed under conditions such that no hydrazide compound is present to obtain a mixture, and an operation in which a hydrazide compound and a vulcanizing-type compounding ingredient are kneaded into the mixture to obtain a rubber composition. A third procedure comprises an operation in which a hydrazide compound and a master batch comprising carbon black and a compound according to Formula (I) are mixed to obtain a mixture, and an operation in which a vulcanizing-type compounding ingredient is kneaded into the mixture.

The first procedure comprises an operation in which a compound according to Formula (I), a hydrazide compound, and a rubber component are mixed to obtain a mixture. At this operation, carbon black, stearic acid, zinc oxide, antioxidant, and/or the like may be mixed therein together with the compound according to Formula (I), the hydrazide compound, and the rubber component.

The first procedure further comprises an operation in which a vulcanizing-type compounding ingredient is kneaded into the mixture. As examples of the vulcanizing-type compounding ingredient, sulfur, organic peroxides, and other such vulcanizing agents, vulcanization accelerators, vulcanization accelerator activators, vulcanization retarders, and so forth may be cited.

The second procedure comprises an operation in which a compound according to Formula (I), an antioxidant, and a rubber component are mixed under conditions such that no hydrazide compound is present to obtain a mixture. At this operation, carbon black, stearic acid, zinc oxide, and/or the like may be mixed therein together with the compound according to Formula (I), the antioxidant, and the rubber component

The second procedure further comprises an operation in which a hydrazide compound and a vulcanizing-type compounding ingredient are kneaded into the mixture to obtain a rubber composition.

At the third procedure, to make the master batch, a method (hereinafter “first master batch manufacturing method”) in which a compound according to Formula (I) and carbon black are added to natural rubber and this is kneaded; a method (hereinafter “second master batch manufacturing method”) in which carbon black is kneaded into natural rubber, and a compound according to Formula (I) is kneaded into the water-containing post-addition-of-carbon-black natural rubber; and a method (hereinafter “third master batch manufacturing method”) comprising an operation in which a carbon-black-containing pre-coagulation rubber latex is coagulated to obtain a coagulum, an operation in which a compound according to Formula (I) is added to the water-containing coagulum, and an operation in which the compound according to Formula (I) is dispersed within the coagulum may be cited by way of example. Of these, the second master batch manufacturing method and the third master batch manufacturing method are preferred, and the third master batch manufacturing method is more preferred. This is so because the second master batch manufacturing method and the third master batch manufacturing method permit a high degree of dispersal of the compound according to Formula (I).

The second master batch manufacturing method and the third master batch manufacturing method permit a high degree of dispersal of the compound according to Formula (I). Because the compound according to Formula (I) is hydrophilic and because rubber in its dried state is hydrophobic, the compound according to Formula (I) tends not to be easily dispersed in the absence of water. In contradistinction thereto, at the second master batch manufacturing method and the third master batch manufacturing method, dispersal of the compound according to Formula (I) may be facilitated by water. The second master batch manufacturing method and the third master batch manufacturing method therefore permit a high degree of dispersal of the compound according to Formula (I).

As previously mentioned, the third master batch manufacturing method comprises an operation in which a carbon-black-containing pre-coagulation rubber latex is coagulated to obtain a coagulum.

To make the pre-coagulation rubber latex, the third master batch manufacturing method may comprise an operation in which carbon black and rubber latex are mixed to obtain a carbon black slurry. Mixing the carbon black and the rubber latex makes it is possible to prevent reflocculation of carbon black. This is thought to be due to formation of an extremely thin latex phase on all or part of the surface of the carbon black, the latex phase inhibiting reflocculation of carbon black. As examples of the carbon black, besides SAF, ISAF, HAF, FEF, GPF, and other such carbon blacks ordinarily used in the rubber industry, acetylene black, Ketchen black, and/or other such electrically conductive carbon blacks may be used. The carbon black may be nongranulated carbon black or may be granulated carbon black that has been granulated based upon considerations related to the handling characteristics thereof as is ordinary practice in the rubber industry. The rubber latex at the operation in which the carbon black slurry is made may for example be natural rubber latex, synthetic rubber latex, and/or the like. The number average molecular weight of natural rubber within the natural rubber latex might, for example, be not less than 2,000,000. The synthetic rubber latex might, for example, be styrene-butadiene rubber latex, butadiene rubber latex, nitrile rubber latex, and/or chloroprene rubber latex. It is preferred that solids (rubber) concentration in the rubber latex be not less than 0.1 mass %, more preferred that this be not less than 0.2 mass %, and still more preferred that this be not less than 0.3 mass %. The upper limit of the range in values for the solids concentration might, for example, be 5 mass %, it being preferred that this be 2 mass %, and it being more preferred that this be 1 mass %. The carbon black and the rubber latex may be mixed using a high-shear mixer, high shear mixer, homomixer, ball mill, bead mill, high-pressure homogenizer, ultrasonic homogenizer, colloid mill, and/or other such ordinary disperser.

In the carbon black slurry, carbon black is dispersed in water. It is preferred that the amount of carbon black in the carbon black slurry be not less than 1 mass %, and more preferred that this be not less than 3 mass %, per 100 mass % of the carbon black slurry. It is preferred that the upper limit of the range in values for the amount of carbon black in the carbon black slurry be 15 mass %, and more preferred that this be 10 mass %.

The third master batch manufacturing method may further comprise an operation in which the carbon black slurry and rubber latex are mixed to obtain the pre-coagulation rubber latex. The rubber latex for mixture with the carbon black slurry may for example be natural rubber latex, synthetic rubber latex, and/or the like. It is preferred that the solids concentration of the rubber latex for mixture with the carbon black slurry be greater than the solids concentration of the rubber latex at the operation in which the carbon black slurry is made. It is preferred that the solids concentration of the rubber latex for mixture with the carbon black slurry be not less than 10 mass %, and more preferred that this be not less than 20 mass %. The upper limit of the range in values for the solids concentration at the rubber latex might, for example, be 60 mass %, it being preferred that this be 40 mass %, and it being more preferred that this be 30 mass %.

The carbon black slurry and the rubber latex may be mixed using a high-shear mixer, high shear mixer, homomixer, ball mill, bead mill, high-pressure homogenizer, ultrasonic homogenizer, colloid mill, and/or other such ordinary disperser.

In the pre-coagulation rubber latex, rubber particles, carbon black, and so forth are dispersed in water.

The third master batch manufacturing method comprises an operation in which the pre-coagulation rubber latex is coagulated to obtain a coagulum. Coagulant may be added to the pre-coagulation rubber latex to cause it to coagulate. The coagulant might, for example, be an acid. As the acid, formic acid, sulfuric acid, and the like may be cited as examples. The coagulum obtained by coagulation of the pre-coagulation rubber latex contains water.

The third master batch manufacturing method further comprises an operation in which a compound according to Formula (I) is added to the coagulum. At the operation in which the compound according to Formula (I) is added, the amount Wa of water in the coagulum might, for example, be not less than 1 part by mass, it being preferred that this be not less than 10 parts by mass, for every 100 parts by mass of rubber within the coagulum. The upper limit of the range in values for Wa might, for example, be 800 parts by mass, it being preferred that this be 600 parts by mass. The amount Wb of compound according to Formula (I) that is added might, for example, be not less than 0.1 part by mass, it being preferred that this be not less than 0.5 part by mass, for every 100 parts by mass of rubber within the coagulum. The upper limit of the range in values for Wb might, for example, be 10 parts by mass, it being preferred that this be 5 parts by mass. It is preferred that the ratio of Wa to Wb (i.e., Wa/Wb) be in the range 1 to 8100. Causing Wa/Wb to be less than 1 would be unlikely to produce much benefit in terms of improvement of fatigue resistance. Above 8100, it might be the case that the water content of the coagulum will remain in the master batch.

The third master batch manufacturing method further comprises an operation in which the compound according to Formula (I) is dispersed within the coagulum. The operation in which the compound according to Formula (I) is dispersed within the coagulum might, for example, be an operation in which the compound according to Formula (I) is dispersed within the coagulum as the post-addition-of-compound-according-to-Formula-(I) coagulum is being dewatered; more specifically, this might be an operation in which the compound according to Formula (I) is dispersed within the coagulum as a shear force is imparted at 100° C. to 250° C. to the post-addition-of-compound-according-to-Formula-(I) coagulum. It is preferred that the lower limit of the range in values for temperature be 120° C. It is preferred that the upper limit of the range in values for temperature be 230° C. A single screw extruder or other such extruder may be used for dispersing the compound according to Formula (I) within the coagulum.

The third master batch manufacturing method may further comprise an operation in which, following dispersal of the compound according to Formula (I), drying and plasticization of the coagulum are carried out to obtain a master batch.

As previously mentioned, the third procedure for making the rubber composition comprises an operation in which a master batch and a hydrazide compound are mixed to obtain a mixture. At this operation, stearic acid, zinc oxide, antioxidant, and/or the like may be mixed therein together with the master batch and the hydrazide compound. The master batch comprises rubber. The rubber might, for example, be natural rubber, polyisoprene rubber, styrene-butadiene rubber, nitrile rubber, chloroprene rubber, and/or the like. It is preferred that the amount of natural rubber in the master batch be not less than 70 mass %, more preferred that this be not less than 80 mass %, still more preferred that this be not less than 90 mass %, and still more preferred that this be 100 mass %, per 100 mass % of the rubber. The master batch further comprises carbon black. For every 100 parts by mass of the rubber, it is preferred that the amount of carbon black be not less than 10 parts by mass, more preferred that this be not less than 20 parts by mass, and still more preferred that this be not less than 30 parts by mass. For every 100 parts by mass of the rubber, it is preferred that the amount of carbon black be not greater than 80 parts by mass, and more preferred that this be not greater than 60 parts by mass. The master batch further comprises a compound according to Formula (I). For every 100 parts by mass of the rubber, it is preferred that the amount of the compound according to Formula (I) be not less than 0.1 part by mass, more preferred that this be not less than 0.5 part by mass, and still more preferred that this be not less than 1 part by mass. For every 100 parts by mass of the rubber, it is preferred that the amount of the compound according to Formula (I) be not greater than 10 parts by mass, and more preferred that this be not greater than 8 parts by mass.

The third procedure for making the rubber composition further comprises an operation in which a vulcanizing-type compounding ingredient is kneaded into the mixture.

A tire manufacturing method in accordance with the present disclosure comprises an operation in which a green tire equipped with a tire member comprising the rubber composition is made. The tire manufacturing method in accordance with the present disclosure further comprises an operation in which the green tire is heated.

### WORKING EXAMPLES

Working examples in accordance with the present disclosure are described below.

Raw materials and reagents are indicated below.

| | |
|---|---|
| Concentrated natural rubber | “LA-NR (DRC = 60%)” manufactured by |
| latex | Regitex Co., Ltd. |
| Coagulant | Formic acid (reagent-grade 85%) |
| | manufactured by Nacalai Tesque, Inc. |
| | (diluted to obtain 10% solution and pH |
| | adjusted to 1.2 prior to use) |
| Natural rubber | RSS #3 |
| Polybutadiene rubber | “BR150B” manufactured by Ube Industries, |
| | Ltd. |
| Carbon Black 1 | “SEAST 6” (N220) manufactured by Tokai |
| | Carbon Co., Ltd. |
| Carbon Black 2 | “SEAST 9H” manufactured by Tokai |
| | Carbon Co., Ltd. |
| Compound 1 | (2Z)-4-[(4-aminophenyl)amino]-4-oxo-2- |
| | butene acid sodium (compound according to |
| | Formula (I′)) manufactured by Sumitomo |
| | Chemical Co., Ltd. |
| Compound 2-1 | “Isophthalic Dihydrazide” manufactured by |
| | Tokyo Chemical Industry Co., Ltd. |
| Compound 2-2 | “3-Hydroxy-N′-(1,3-dimethylbutylidene)-2- |
| | naphthoic acid hydrazide” manufactured by |
| | Otsuka Chemical Co., Ltd. |
| Stearic acid | “Stearic Acid Beads” manufactured by NOF |
| | Corporation |
| Zinc oxide | “Zinc Oxide Variety No. 2” manufactured |
| | by Mitsui Metal Mining Co., Ltd. |
| Antioxidant | “Antigen 6C” (N-phenyl-N′-(1,3- |
| | dimethylbutyl)-p-phenylenediamine) |
| | manufactured by Sumitomo Chemical Co., |
| | Ltd. |
| Sulfur | “Powdered Sulfur” manufactured by |
| | Tsurumi Chemical Industry Co., Ltd. |
| Vulcanization accelerator | “Sanceler CM-G” (N-cyclohexyl-2- |
| | benzothiazolylsulfenamide) manufactured by |
| | Sanshin Chemical Industry Co., Ltd. |

### Preparation of Unvulcanized Rubber at Comparative Examples 1 Through 5 and Working Examples 1 Through 4, 8, and 9

The compounding ingredients except for sulfur and vulcanization accelerator were added in accordance with TABLE 1, a Model B Banbury mixer manufactured by Kobe Steel, Ltd., was used to carry out kneading, and the rubber mixture was discharged. The rubber mixture was then kneaded together with sulfur and vulcanization accelerator in a Model B Banbury mixer to obtain unvulcanized rubber.

Preparation of Unvulcanized Rubber at Working Example 5

The compounding ingredients except for sulfur, vulcanization accelerator, and Compound 2-1 were added in accordance with TABLE 1, a Model B Banbury mixer manufactured by Kobe Steel, Ltd., was used to carry out kneading, and the rubber mixture was discharged. The rubber mixture was then kneaded together with sulfur, vulcanization accelerator, and Compound 2-1 in a Model B Banbury mixer to obtain unvulcanized rubber.

Preparation of Unvulcanized Rubber at Working Example 6

Carbon Black 1 and Compound 1 were kneaded into natural rubber in accordance with TABLE 1 to obtain a dry master batch. The compounding ingredients except for sulfur and vulcanization accelerator were added to the dry master batch in accordance with TABLE 1, a Model B Banbury mixer manufactured by Kobe Steel, Ltd., was used to carry out kneading, and the rubber mixture was discharged. The rubber mixture was then kneaded together with sulfur and vulcanization accelerator in a Model B Banbury mixer to obtain unvulcanized rubber.

Preparation of Unvulcanized Rubber at Working Example 7

Carbon Black 1 was kneaded into natural rubber in accordance with TABLE 1. Compound 1 and water were added to and kneaded into the post-kneading-of-carbon-black natural rubber in accordance with TABLE 1 to obtain a dry master batch. A Model B Banbury mixer manufactured by Kobe Steel, Ltd., was used to knead Compound 2-1, stearic acid, zinc oxide, and antioxidant into the dry master batch in accordance with TABLE 1, and the rubber mixture was discharged. The rubber mixture was then kneaded together with sulfur and vulcanization accelerator in a Model B Banbury mixer to obtain unvulcanized rubber.

Preparation of Unvulcanized Rubber at Working Example 10

Water was added at 25° C. to concentrated natural rubber latex to obtain a dilute natural rubber latex having a solids (rubber) concentration that was 0.52 mass %, and a natural rubber latex having a solids (rubber) concentration that was 28 mass %. 50 parts by mass of Carbon Black 1 was added to 954.8 parts by mass of the dilute natural rubber latex, and a ROBO MIX manufactured by PRIMIX Corporation was used to agitate the post-addition-of-carbon-black dilute natural rubber latex to obtain a carbon black/natural rubber slurry. The carbon black/natural rubber slurry was added to the natural rubber latex having the solids (rubber) concentration that was 28 mass % in accordance with TABLE 1, and a mixer for household use manufactured by SANYO was used to agitate the post-addition-of-carbon-black/natural-rubber-slurry natural rubber latex at 11300 rpm for 30 min to obtain a pre-coagulation rubber latex. Formic acid serving as coagulant was added to the pre-coagulation rubber latex in an amount sufficient to achieve a pH of 4, and a filter was used to separate the coagulum from waste liquid. Compound 1 was added to the coagulum, and Compound 1 was dispersed within the coagulum as a Model V-02 screw press (squeezer-type single-screw dewatering extruder) manufactured by Suehiro EPM Corporation was used to dewater/plasticize at 180° C. the post-addition-of-Compound-1 coagulum. As a result of the foregoing procedure, a wet master batch was obtained. A Model B Banbury mixer manufactured by Kobe Steel, Ltd., was used to knead Compound 2-1, stearic acid, zinc oxide, and antioxidant into the wet master batch in accordance with TABLE 1, and the rubber mixture was discharged. The rubber mixture was then kneaded together with sulfur and vulcanization accelerator in a Model B Banbury mixer to obtain unvulcanized rubber.

Heat Generation

The unvulcanized rubber was vulcanized at 150° C. for 30 min, and heat generation performance was evaluated based on the value of tanδ as measured using a viscoelastic spectrometer manufactured by Toyo Seiki at initial strain 10%, dynamic strain 2%, frequency 50 Hz, and temperature 60° C. Heat generation is shown as indexed relative to a value of 100 for Comparative Example 1. This means that the smaller the index the more excellent it was in terms of having low heat generation.

TABLE 1

| | | | | Comparative Example | | | | | Working Example | | | | | | | | | |
|---|---|---|---|---|---|---|---|---|---|---|---|---|---|---|---|---|---|---|
| | | | | 1 | 2 | 3 | 4 | 5 | 1 | 2 | 3 | 4 | 5 | 6 | 7 | 8 | 9 | 10 |
| Manufacture | Parts by mass | | Natural rubber | — | — | — | — | — | — | — | — | — | — | 100 | 100 | — | — | — |
| dry master | | | Carbon Black 1 | — | — | — | — | — | — | — | — | — | — | 50 | 50 | — | — | — |
| batch | | | Compound 1 | — | — | — | — | — | — | — | — | — | — | 0.5 | 0.5 | — | — | — |
| | | | Water content | — | — | — | — | — | — | — | — | — | — | — | 3 | — | — | — |
| | | | Wa/Wb | — | — | — | — | — | — | — | — | — | — | — | 6 | — | — | — |
| Manufacture | Parts by mass | | Natural rubber | — | — | — | — | — | — | — | — | — | — | — | — | — | — | 100 |
| wet master | | | (solids content) | | | | | | | | | | | | | | | |
| batch | | | Carbon Black 1 | — | — | — | — | — | — | — | — | — | — | — | — | — | — | 50 |
| | | | Compound 1 | — | — | — | — | — | — | — | — | — | — | — | — | — | — | 0.5 |
| | | | Water content | — | — | — | — | — | — | — | — | — | — | — | — | — | — | 602 |
| | | | Wa/Wb | — | — | — | — | — | — | — | — | — | — | — | — | — | — | 1204 |
| Manufacture | Nonproduction | Parts by | Master batch | — | — | — | — | — | — | — | — | — | — | 150.5 | 150.5 | — | — | 150.5 |
| unvulcanized | kneading | mass | Natural rubber | 100 | 100 | 100 | 100 | 70 | 100 | 100 | 100 | 100 | 100 | — | — | 100 | 70 | — |
| rubber | | | Polybutadiene | — | — | — | — | 30 | — | — | — | — | — | — | — | — | 30 | — |
| | | | rubber | | | | | | | | | | | | | | | |
| | | | Carbon Black 1 | 50 | 50 | 50 | — | 50 | 50 | 50 | 50 | 50 | 50 | — | — | — | 50 | — |
| | | | Carbon Black 2 | — | — | — | 50 | — | — | — | — | — | — | — | — | 50 | — | — |
| | | | Compound 1 | — | — | 1 | — | — | 0.5 | 0.5 | 0.1 | 2 | 0.5 | — | — | 0.5 | 0.5 | — |
| | | | Compound 2-1 | — | 1 | — | — | — | 0.5 | — | 0.9 | 2 | — | 0.5 | 0.5 | 0.5 | 0.5 | 0.5 |
| | | | Compound 2-2 | — | — | — | — | — | — | 0.5 | — | — | — | — | — | — | — | — |
| | | | Stearic acid | 1 | 1 | 1 | 1 | 1 | 1 | 1 | 1 | 1 | 1 | 1 | 1 | 1 | 1 | 1 |
| | | | Zinc oxide | 3 | 3 | 3 | 3 | 3 | 3 | 3 | 3 | 3 | 3 | 3 | 3 | 3 | 3 | 3 |
| | | | Antioxidant | 1 | 1 | 1 | 1 | 1 | 1 | 1 | 1 | 1 | 1 | 1 | 1 | 1 | 1 | 1 |
| | Production | Parts by | Compound 2-1 | — | — | — | — | — | — | — | — | — | 0.5 | — | — | — | — | — |
| | kneading | mass | Sulfur | 2 | 2 | 2 | 2 | 2 | 2 | 2 | 2 | 2 | 2 | 2 | 2 | 2 | 2 | 2 |
| | | | Vulcanization | 1 | 1 | 1 | 1 | 1 | 1 | 1 | 1 | 1 | 1 | 1 | 1 | 1 | 1 | 1 |
| | | | accelerator | | | | | | | | | | | | | | | |

| | | | | | | | | | | | | | | | |
|---|---|---|---|---|---|---|---|---|---|---|---|---|---|---|---|
| Heat generation | 100 | 96 | 98 | 100 | 100 | 91 | 92 | 89 | 81 | 80 | 85 | 82 | 92 | 91 | 80 |

Combined use of Compound 1 with Compound 2-1 or Compound 2-2 caused improvement in heat generation. For example, combined use of 0.5 part by mass of Compound 1 and 0.5 part by mass of Compound 2-1 caused improvement in an amount corresponding to 9 points (see Comparative Example 1 and Working Example 1). Combined use of 0.1 part by mass of Compound 1 and 0.9 part by mass of Compound 2-1 caused improvement in an amount corresponding to 11 points (see Comparative Example 1 and Working Example 3). On the other hand, 1 part by mass of Compound 1 caused improvement in an amount corresponding to 2 points (see Comparative Example 1 and Comparative Example 3). 1 part by mass of Compound 2-1 caused improvement in an amount corresponding to 4 points (see Comparative Example 1 and Comparative Example 2).

Addition of Compound 2-1 not at the stage when nonproduction kneading was carried out but at the stage when production kneading was carried out caused increased benefit in terms of reduction in heat generation (see Working Example 1 and Working Example 5).

Employment of a procedure in which Compound 1 and Carbon Black 1 were kneaded into natural rubber to obtain a dry master batch caused increased benefit in terms of reduction in heat generation (see Working Example 1 and Working Example 6).

Employment of a procedure in which Compound 1 and water were added to post-kneading-of-carbon-black natural rubber, and this was kneaded to obtain a dry master batch caused increased benefit in terms of reduction in heat generation (see Working Example 1 and Working Example 7).

Employment of a procedure in which Compound 1 was dispersed within a coagulum containing carbon black and water to obtain a wet master batch caused increased benefit in terms of reduction in heat generation (see Working Example 1 and Working Example 10).

1. A tire member comprising a rubber composition;
wherein the rubber composition comprises a compound according to Formula (I), a hydrazide compound, and carbon black;
wherein Formula (I) is given by 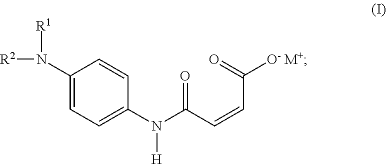
and wherein, at Formula (I), R¹ and R² each indicates a hydrogen atom, an alkyl group having 1 to 20 carbons, an alkenyl group having 1 to 20 carbons, or an alkynyl group having 1 to 20 carbons;
R¹ and R² may be the same or different; and
M⁺ indicates sodium ion, potassium ion, or lithium ion.

2. The tire member according to claim 1 wherein the hydrazide compound comprises a dihydrazide compound.

3. A tire comprising the tire member according to claim 1.

4. A tire member manufacturing method comprising an operation in which a rubber composition comprising a compound according to Formula (I), a hydrazide compound, and carbon black is made;
wherein Formula (I) is given by 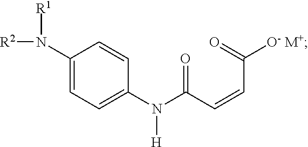
and wherein, at Formula (I), R¹ and R² each indicates a hydrogen atom, an alkyl group having 1 to 20 carbons, an alkenyl group having 1 to 20 carbons, or an alkynyl group having 1 to 20 carbons;
R¹ and R² may be the same or different; and
M⁺ indicates sodium ion, potassium ion, or lithium ion.

5. A tire manufacturing method comprising the tire member manufacturing method according to claim 4.
